(19) United States
(12) Patent Application Publication
(10) Pub. No.: US 2007/0058671 A1
(43) Pub. Date: Mar. 15, 2007

(54) Method and apparatus for packetization of data frames

(76) Inventors: Thomas B. Hart, West Dundee, IL (US); Ronald T. Crocker, St. Charles, IL (US); John M. Harris, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/225,234

(22) Filed: Sep. 13, 2005

(51) Int. Cl. H04J 3/16

(52) U.S. Cl. 370/466

(57) ABSTRACT

A receiving buffer (110) in communication with a processing circuit (150) stores (310) received packets of data while the processing circuit (150) strips (320) the frames of data from the packets. The stripped frames are stored (330), and the processing circuit (150) creates and stores (340) reformed packets using the frames. Preferably, the processing circuit (150) creates the reformed packets according to one or more certain predefined functions of one or more conditions monitored by a condition monitor (130) which indicate the possible size of the next available radio frame in which the packets are wirelessly transmitted. Then, the processing circuit (150) sends the reformed packet that ideally matches the size of the radio frame to be sent with the radio frame.

### TECHNICAL FIELD

This invention generally relates to communication systems and more particularly to wireless communication systems that transmit data using packets of data carried within radio frames.

### BACKGROUND

Various communication systems are known in the art. In many such systems, the data to be transmitted are typically grouped into packets such that each packet is transmitted as a whole within the wired network. In other words, typically, the packet does not begin transmission across a link until the entire packet has arrived across the previous link. Packets typically include the data that is transmitted and header information. Before being collected into packets, in the case of a voice call, the data are typically grouped into frames for ease of handling such as vocoded (voice coded) frames when carrying voice data or other frames, i.e. sets of data, when carrying other types of data. The information carried in the header allows the packet to be routed through the communication system. In a typical wireless communication system, the packet typically reaches a radio access network or base transceiver station just before being wirelessly sent to a target or receiving mobile station. Then, the packets wait at the radio access network or base transceiver station until a radio frame is assigned by the system to carry the waiting packets, including the header information and frames of data, to the receiving mobile station. A mobile station is any wireless communication device such as a mobile phone, a wireless network card, a personal data assistant, and so forth.

The size of the radio frame assigned to carry the packets to the receiving mobile station, however, often does not match the size of the packets, typically causing inefficiencies in the system. For instance, if the radio frame size is relatively large, multiple packets may fit into the radio frame. When fitting multiple packets into the radio frame, multiple headers must also be carried in the frame. The multiple headers waste space within the radio frame that could be dedicated to carrying the transmitted data. In a different situation, a single packet may be stored across multiple radio frames. In this situation, if one of the radio frames fails to properly transmit to the mobile station, the packet that spanned the two frames typically cannot be read. Thus, by losing one radio frame, two radio frame's data may be lost or delayed.

A further complication typical in such wireless communication systems is that the size of the radio frames can vary over a short amount of time. Therefore, it is often difficult to set a packet size in advance to match a radio frame size in order to minimize the inefficiencies.

### BRIEF DESCRIPTION OF THE DRAWINGS

The above needs are at least partially met through provision of the method and apparatus for packetization of data frames described in the following detailed description, particularly when studied in conjunction with the drawings, wherein:

FIG. 1 is a block diagram of certain components as configured in accordance with various embodiments of the invention;

FIG. 2 is a block diagram of a wireless communication system as configured in accordance with various embodiments of the invention;

FIG. 3 is a flow diagram as configured in accordance with various embodiments of the invention;

FIG. 4 is a flow diagram as configured in accordance with various embodiments of the invention;

FIG. 5 is a flow diagram as configured in accordance with various embodiments of the invention; and

FIG. 6 is a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a receiving buffer stores received packets of data, and an associated processor circuit strips the frames of data from the received packets of data. The stripped frames are then stored. The processor circuit will then create and store reformed packets using the frames. Preferably, the reformed packets are created according to a predetermined function of one or more monitored conditions such that the reformed packets are more likely to fit the radio frames. Then, the processor will send a reformed packet that best fits the radio frame when the radio frame is made available in which to send the packets.

By fitting the reformed packets to the radio frames, inefficiencies are avoided such as wasting too much radio frame space on header information or splitting packets across radio frames. Further, by preparing multiple possible reformed packets before the radio frame is available, there is no delay in handing over an optimal packet to the radio access frame.

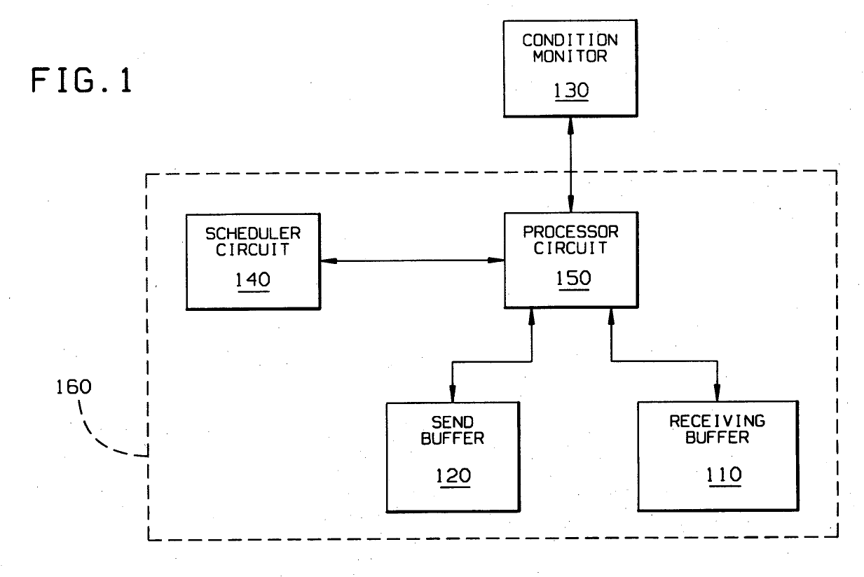

Referring now to the drawings, and in particular to FIG. 1, a receiving buffer 110 receives and stores packets of data. A send buffer 120 stores reformed packets. A condition monitor 130 and scheduler circuit 140 are in communication with a processor circuit 150 such that the processor circuit 150 may receive signals from and send signals to the condition monitor 130 and scheduler circuit 140. The processor circuit 150 is also in communication with the receiving buffer 110 to control the handling of the data packets in the receiving buffer 110. Further, the processor circuit 150 is in communication with the send buffer 120 to control the handling of the reformed packets in the send buffer 120.

A preferred embodiment includes the receiving buffer 110, send buffer 120, scheduler circuit 140, and processor circuit 150 in a single integrated component 160 with associated software elements in communication with the condition monitor 130 that may or may not be remotely located from the integrated component 160. Alternatively, the scheduler circuit 140 also may be located remotely from the integrated component 160.

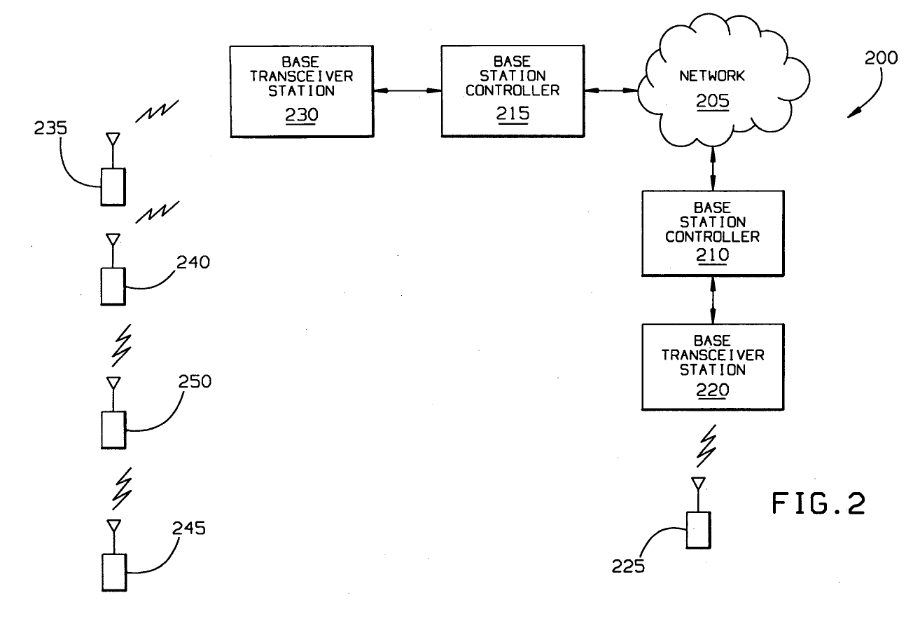

With reference to FIG. 2, the wireless communication system 200 includes a common network 205, such as the Internet or other common communication network, in communication with a plurality of base station controllers 210 and 215. A base station controller 210 is in communication with a base transceiver station 220 which in turn is in communication with a mobile station 225. Similarly, a base station controller 215 is in communication with base transceiver station 230 which is in wireless communication with one or more mobile stations 235 and 240. In certain embodiments, the base transceiver station 230 is in wireless communication with a mobile station 245 through intervening mobile stations 250 and 240. In such embodiments, data is transmitted directly from one mobile station to another.

The apparatus of FIG. 1 can be incorporated or integrated into any one or more of several structures within the wireless communication system 200 through which data may travel during transmission. For instance and with continued reference to FIG. 2, assuming that the sending mobile station 235 is sending data through the wireless communication system 200 to a receiving mobile station 225, the integrated component 160 may be integrated within the sending mobile station 235. Alternatively, the integrated component 160 may be integrated within a radio access network or other component such as a base transceiver station 230 in communication with the sending mobile station 235 or a base transceiver station 220 in communication with the receiving mobile station 225. It will be understood by one skilled in the art that a base transceiver station and sometimes a base station controller are components of a typical radio access network. In another alternative, the integrated component 160 is integrated into a base station controller 215 or 210. In the embodiment where data is transmitted directly from mobile station to mobile station, the integrated component 160 can be integrated into an intervening mobile station 250.

Similarly, the condition monitor 130 can be incorporated into one or more various structures within the wireless communication system 200. The condition monitor 130 monitors any condition of the wireless communication system 200 that may bear on the transmission of data. For example, the condition monitor 130 may include a quality of signal monitor, a type of wireless transmission technology monitor, an amount of unrendered data at a receiving mobile station monitor, an amount of receiving mobile station buffer space monitor, an amount of data to send to a receiving mobile station monitor, an amount of data to send from a sending mobile station monitor, a location of a receiving mobile station relative to a sending mobile station monitor, and a location of at least two mobile stations participating in a group call monitor.

One skilled in the art will recognize that the various individual circuits, buffers, monitors, and other elements described herein, when combined as described to form an embodiment of the invention, are readily designed and connected by one skilled in the art and may operate in conjunction with various software elements to perform according to this description. For example, the monitors are typically known or readily designed circuitry that together with various software elements can monitor the various factors as described herein. Other enabling structure can be applied by those skilled in the art as desired as well.

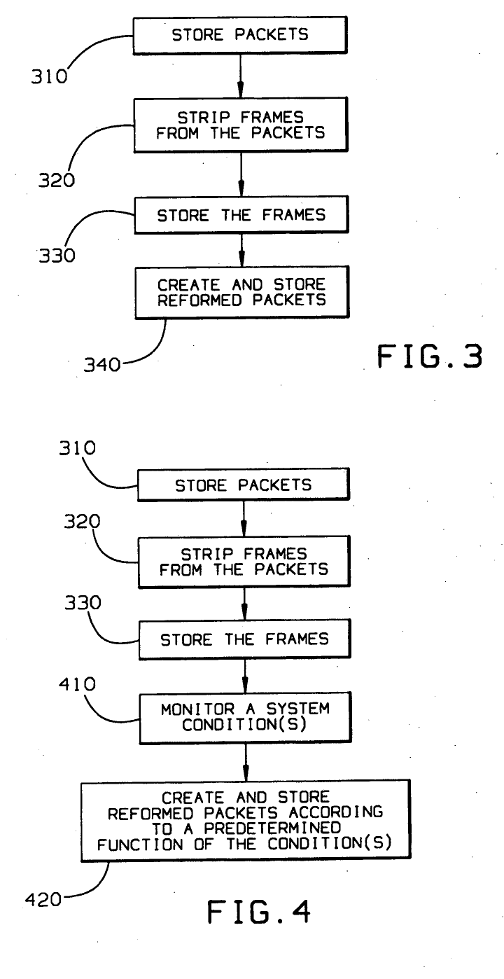

A method of operation of the above elements will be described with reference to FIG. 3. The receiving buffer 110 stores 310 received packets of data. The processor circuit 150 in combination with the receiving buffer 110 strips 320 frames of data from the received packets of data. Depending on the embodiment, the received packets may be packets received from other components of the wireless communication system 200, or when incorporated into the sending mobile station 235, the received packets are packets of data determined by the sending mobile station 235 to be sent such as voice data taken from the user of the sending mobile station 235. Stripping 320 frames of data from the packets typically involves removing the header data from the packet and separately storing the data frames intended to be transmitted. The stripped frames are stored 330 in the send buffer 120 or other appropriate memory circuitry. Then, the processor circuit 150 creates and stores 340 reformed packets using the frames.

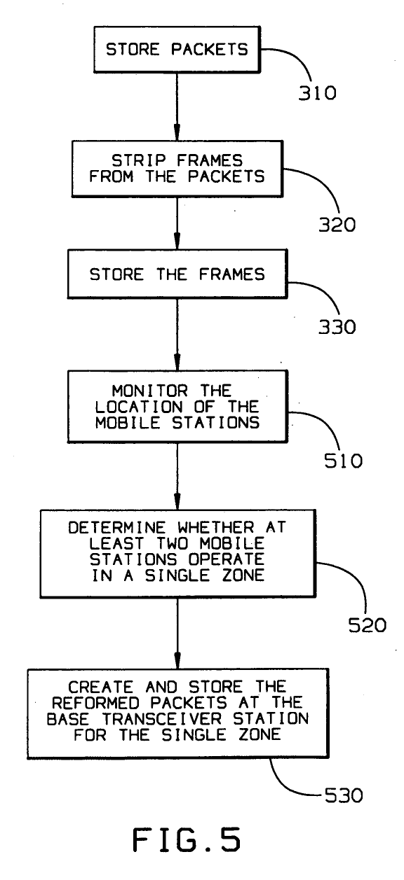

A preferred embodiment will be described with reference to FIG. 4. The steps of storing 310 packets, stripping 320 the frames from the packets, and storing 330 the stripped frames are performed according to the above description. Then, the condition monitor 130 monitors 410 a condition (or conditions) of the wireless communication system 200. The processor circuit 150 then creates and stores 420 reformed packets according to a predetermined function of the monitored condition.

In one alternative, a quality of signal monitor monitors the quality of signal for a mobile station. The mobile station in this alternative may be either the sending mobile station 235 or the receiving mobile station 225, and the quality of signal monitor is preferably located in the monitored mobile station 225 or 235 or the corresponding base transceiver station 220 or 230, respectively. In this alternative, the processor circuit 150 and associated components are preferably located in the monitored sending mobile station 235 or the receiving base transceiver station 220 when monitoring the signal strength of the receiving mobile station 225. In operation, the quality of signal monitor sends a signal indicating the quality of the monitored signal for the monitored mobile station to the processor circuit 150. The processor circuit 150 then creates and stores the reformed packets with a smaller number of frames when monitoring that the quality of signal for the monitored mobile station is below a predetermined quality level. The smaller radio frames typically have more redundancy and error resiliency and thus for this reason and other reasons these smaller radio frames are typically more likely to be successfully transmitted. Therefore, the smaller radio frames are preferentially used when the quality of signal for the mobile station is low; thus, the scheduling circuit 140 will likely assign radio frames of a smaller size. Therefore, by having previously created reformed packets of smaller size, there is at least a reduced likelihood that a packet will be split among multiple radio frames.

In another alternative, a type of wireless transmission technology monitor monitors the type of wireless transmission technology utilized for the wireless communication system 200. The type of wireless transmission technology monitor may be located anywhere within the wireless communication system 200, and is preferably located near the processor circuit 150. The processor circuit 150 and associated components in this alternative are preferably located in the sending mobile station 235 or the receiving base transceiver station 220. In operation, the type of wireless transmission technology monitor sends a signal indicating the type of wireless transmission technology utilized for the particular data transmission to the processor circuit 150. The processor circuit 150 then creates and stores the reformed packets using a structure corresponding to that particular type of wireless transmission technology. One skilled in the art will recognize that this embodiment is preferably used in wireless communication systems 200 that employ a plurality of communication technologies.

In yet another alternative, an amount of unrendered data at a receiving mobile station monitor monitors the amount of unrendered data at the receiving mobile station 225. The amount of unrendered data at a receiving mobile station monitor is preferably located in the receiving mobile station 225. In this alternative, the processor circuit 150 and associated components are preferably located in the receiving base transceiver station 220. In operation, the amount of unrendered data at a receiving mobile station monitor sends a signal indicating the amount of unrendered data at the receiving mobile station 225 to the processor circuit 150. The processor circuit 150 then creates and stores the reformed packets with a higher number of frames when monitoring that the amount of unrendered data at the receiving mobile station 225 is below a predetermined level. Larger radio frames transmit more data to the receiving mobile station 225, thus ensuring that the data stream playout at the receiving mobile station 225 will not run out of data and thereby typically improving the quality of use for the user. Thus, if the amount of unrendered data is low, larger radio frames are likely to be assigned which are more likely to match the size of the reformed packets with a higher number of frames. One skilled in the art will recognize that the data to be rendered may include voice data for a typical voice call, video data, multimedia data, or any other information that is streamed to a receiving mobile station.

In still another alternative, a receiving mobile station buffer space monitor monitors the amount of buffer space available at the receiving mobile station 225. The receiving mobile station buffer space monitor is preferably located in the receiving mobile station 225. In this alternative, the processor circuit 150 and associated components are preferably located in the receiving base transceiver station 220. In operation, the receiving mobile station buffer space monitor sends a signal indicating the amount of buffer space available at the receiving mobile station 225 to the processor circuit 150. The processor circuit 150 then creates and stores the reformed packets with a higher number of frames when monitoring that the amount of buffer space available at the receiving mobile station 225 is above a predetermined level. Larger radio frames transmit more data to the receiving mobile station 225, thus typically more quickly filling up the buffer at the receiving mobile station 225 and thereby more efficiently using that buffer space. Thus, if the amount of buffer space is high, larger radio frames are likely to be assigned which are more likely to match the size of the reformed packets with a higher number of frames.

In a further alternative, an amount of data to send to a receiving mobile station monitor monitors the amount of data to send to the receiving mobile station 225. The amount of data to send to a receiving mobile station monitor is preferably located in the receiving base transceiver station 220. In this alternative, the processor circuit 150 and associated components are also preferably located in the receiving base transceiver station 220. In operation, the amount of data to send to a receiving mobile station monitor sends a signal indicating the amount of data to send to the receiving mobile station 225 to the processor circuit 150. The processor circuit 150 then creates and stores the reformed packets with an increased amount of data when monitoring that a predetermined amount of data is stored and ready to be sent to the receiving mobile station 225. Thus, the system likely will send larger radio frames to transmit more data to the receiving mobile station 225 when an elevated level of data is waiting to be sent to the receiving mobile station 225 thereby more effectively managing the transmitted data. Therefore, if the amount of data ready to be sent is high, larger radio frames are likely to be assigned which are more likely to match the size of the reformed packets with an increased amount of data.

In a variation on this alternative, the processor circuit 150 may also create and store reformed packets with full header updates when monitoring that a predetermined low amount of data is stored and ready to be sent to the receiving mobile station 225. Because a low amount of data is ready to be sent to the receiving mobile station 225, it is economical to use the space within the radio frame to perform a full header update, which one skilled in the art will recognize must be completed from time to time.

In yet another alternative, an amount of data to send from a sending mobile station monitor monitors the amount of data to send from a sending mobile station 235. The amount of data to send from a sending mobile station monitor is preferably located in the sending mobile station 235. In this alternative, the processor circuit 150 and associated components are preferably located in the sending base transceiver station 230 or the sending mobile station 235. In operation, the amount of data to send from a sending mobile station monitor sends a signal indicating the amount of data to send from a sending mobile station 235 to the processor circuit 150. The processor circuit 150 then creates and stores the reformed packets with an increased amount of data when monitoring that a predetermined amount of data is stored and ready to be sent from the sending mobile station. Thus, the system likely will send larger radio frames to transmit more data from the sending mobile station 235 when an elevated level of data is waiting to be sent from the sending mobile station 235 thereby more effectively managing the transmitted data. Therefore, if the amount of data ready to be sent is high, larger radio frames are likely to be assigned which are more likely to match the size of the reformed packets with an increased amount of data.

A further alternative embodiment will be described with reference to FIG. 5. The steps of storing 310 packets, stripping 320 the frames from the packets, and storing 330 the stripped frames are performed according to the above description. Then, the condition monitor 130 monitors 510 the location of at least two mobile stations 235 and 240 and determines 520 whether the mobile stations 235 and 240 operate in a single zone. The zone is preferably the coverage area for a base transceiver station 230, although alternatively the zone may be the area controlled by a base station controller 215. If the mobile stations 235 and 240 are operating in a single zone, the processor circuit 150 and associated structure at the base transceiver station 230 or the base station controller 215 create and store 530 the reformed packets for the zone.

In one version of this alternative embodiment, the condition monitor 130 includes a location of a receiving mobile station relative to a sending mobile station monitor that monitors 510 the location of a receiving mobile station 240 relative to a sending mobile station 235. In response to determining 520 that the sending mobile station 235 and receiving mobile station 240 are operating in a single zone, the processor circuit 150 and associated structure create and store 530 the reformed packets at a base transceiver station 230 for the single zone without downloading the packets from a network 205 to the base transceiver station 230.

In other words, packets from the sending mobile station 235 received at the base transceiver station 230 may be stored 310, data frames may be stripped 320 from the received packets, and reformed packets may be created and stored all at the base transceiver station 230. Then the reformed packet that corresponds to a radio frame for sending data to the receiving mobile station 240 may be sent from the base transceiver station 230 without downloading the packets back from the network 205, and (in the case where there are no group call participants which are outside of that base transceiver station coverage area) without sending the packets into the network 205. In this way, the wireless communication system 200 reduces system traffic by eliminating the need to send data down the communication chain when the data is already accessible within the occupied zone.

For example, if the sending mobile station 235 and the receiving mobile station 240 are in a group call, the data from the sending mobile station 235 should not have to be downloaded from the network 205 to the receiving mobile station 240. Instead, the base transceiver station 230 can route the data back to the receiving mobile station 240 once the data is received from the sending mobile station 235. In another example, if the sending mobile station 235 and the receiving mobile station 240 are operating a private call in the same zone controlled by a base station controller 215, the base station controller 215 can create reformed packets and send the reformed packets or best reformed packet to the receiving mobile station 240 without downloading packets from the network 205 or sending packets into the network.

In another version of this alternative embodiment, the condition monitor 130 includes a location of at least two mobile stations participating in a group call monitor that monitors 510 the location of at least two mobile stations 235 and 240 participating in a group call. In response to determining 520 that at least two mobile stations 235 and 240 participating in the group call are operating in a single zone, the processor circuit 150 and associated structure create and store 530 at a base transceiver station 230 for the single zone the reformed packets using frames of data from each of the at least two mobile stations 235 and 240 before sending the reformed packets into a network 205. In this way, the wireless communication system 200 reduces system traffic by consolidating two or more data streams, one from each group call participant in the zone, before sending the data up the communication chain and into the network 205.

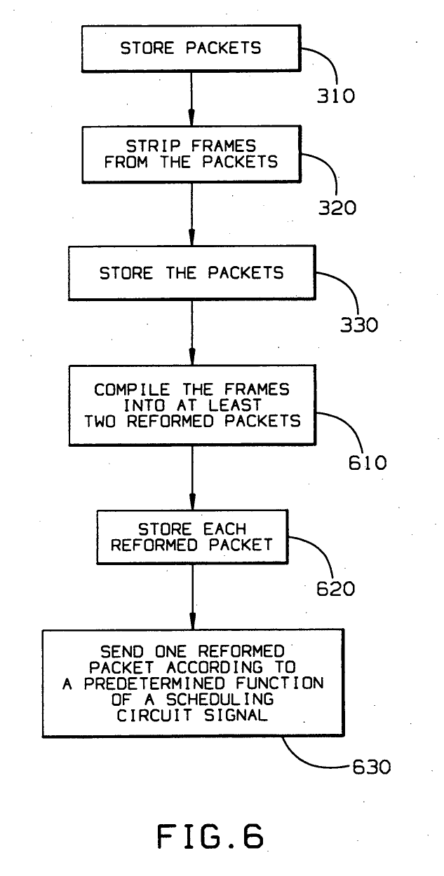

Another embodiment will be discussed with reference to FIG. 6. The steps of storing 310 packets, stripping 320 the frames from the packets, and storing 330 the stripped frames are performed according to the above description. Then, the processor circuit 150 compiles 610 the frames into at least two reformed packets to be sent. The reformed packets are preferably packets most likely to fit the next radio frame for wirelessly sending the data as determined according any of the above described embodiments. The processor circuit 150 then stores 620 each reformed packet in a send buffer 120 or similar memory circuitry. Then, the processor circuit 150 sends 630 one reformed packet according to a predetermined function of a signal received from a scheduling circuit 140. In one example, the predetermined function provides a maximum efficiency of matching reformed packets to the radio frames.

In one variation of the embodiment, the processor circuit 150 receives a signal from the scheduling circuit 140 indicating the size of a radio frame in which data is to be transmitted to or from a mobile station 225. The processor circuit 150 then determines which reformed packet corresponds to the size of the radio frame and sends the reformed packet that corresponds to the size of the radio frame in the radio frame to the mobile station 225. Ideally, the reformed packet has a size that is exactly the size of the radio frame to maximize the efficiency. One skilled in the art, however, will recognize that a reformed packet of a size slightly smaller than the radio frame will provide a satisfactory efficiency level as well.

In another variation of the embodiment, the processor circuit 150 receives a signal from the scheduling circuit 140 indicating that immediately consecutive radio frames are assigned to a single mobile station 225. The processor circuit 150 then determines which reformed packet corresponds to the size of the immediately consecutive radio frames and sends the reformed packet that corresponds to the size of the immediately consecutive radio frames to the mobile station 225. Because the radio frames are consecutively sent to the mobile station 225, one skilled in the art will recognize that certain efficiencies can be gained by spanning a single packet across the immediately consecutive frames.

In a further embodiment, the receiving buffer 110 stores at least a second set of received packets of data. The second set of received packets of data may come from a second source of data being sent to the same mobile station 225 as the first set of received packets. For example, the receiving mobile station 225 may be on a group call and is receiving multiple streams of data. In such an embodiment, the processor circuit 150 and associated structure are preferably located at the receiving base transceiver station 230 or base station controller 210. The processor circuit 150 in combination with the receiving buffer 110 strips frames of data from the second set of received packets of data. The stripped frames from the second set of received packets of data are stored in the send buffer 120 or other appropriate memory circuitry. Then, the processor circuit 150 creates and stores reformed packets using the frames from the first and second sets of received packets of data. Thus, further efficiencies are achieved by combining the two separate data streams with a common destination into a single set of reformed packets.

Thus, the above embodiments increase efficient use of radio frame space by reducing the amount of header data sent within the radio frame. Further, by creating and storing a plurality of possible packets before the radio frame is available, little time is wasted in preparing a packet once the radio frame is ready. Of course, one skilled in the art will recognize that a wide variety of modifications, alterations, and combinations can be made with respect to the above described embodiments without departing from the spirit and scope of the invention. For instance, the various above embodiments may be implemented separately or in various combinations to maximize the possible efficiencies for any given system. Further, those skilled will recognize that the various embodiments can be applied in any packet based or radio frequency communication systems. Such modifications, alterations, and combinations are to be viewed as being within the ambit of the inventive concept.

We claim:

1. A method comprising:
storing received packets of data;
stripping frames of data from the received packets of data;
storing the frames;
creating and storing reformed packets using the frames.

2. The method of claim 1 wherein creating and storing reformed packets using the frames further comprises monitoring a condition of a wireless communication system and creating and storing the reformed packets according to a predetermined function of the monitored condition.

3. The method of claim 2 wherein creating and storing the reformed packets according to a predetermined function of the monitored condition further comprises:
monitoring a quality of signal for a mobile station; and
creating and storing the reformed packets with a smaller number of frames when monitoring that the quality of signal for the mobile station is below a predetermined quality level.

4. The method of claim 2 wherein creating and storing the reformed packets according to a predetermined function of the monitored condition further comprises:
monitoring a type of wireless transmission technology utilized for the wireless communication system; and
creating and storing reformed packets using a structure corresponding to the monitored type of wireless transmission technology utilized by the wireless communication system.

5. The method of claim 2 wherein creating and storing the reformed packets according to a predetermined function of the monitored condition further comprises:
monitoring an amount of unrendered data stored at a receiving mobile station; and
creating and storing reformed packets with a higher number of frames when monitoring that the amount of unrendered data at the receiving mobile station is below a predetermined level.

6. The method of claim 2 wherein creating and storing the reformed packets according to a predetermined function of the monitored condition further comprises:
monitoring an amount of buffer space available at a receiving mobile station; and
creating and storing reformed packets with a higher number of voice frames when monitoring that the amount of buffer space available at the receiving mobile station is above a predetermined level.

7. The method of claim 2 wherein creating and storing the reformed packets according to a predetermined function of the monitored condition further comprises:
monitoring an amount of data to send to a receiving mobile station; and
creating and storing reformed packets with an increased amount of data when monitoring that a predetermined amount of data is stored and ready to be sent to the receiving mobile station.

8. The method of claim 2 wherein creating and storing the reformed packets according to a predetermined function of the monitored condition further comprises:
monitoring an amount of data to send to a receiving mobile station; and
creating and storing reformed packets with full header updates when monitoring that a predetermined low amount of data is stored and ready to be sent to the receiving mobile station.

9. The method of claim 2 wherein creating and storing the reformed packets according to a predetermined function of the monitored condition further comprises:
monitoring an amount of data to send from a sending mobile station; and
creating and storing reformed packets with an increased amount of data when monitoring that a predetermined amount of data is stored and ready to be sent from the sending mobile station.

10. The method of claim 2 wherein creating and storing the reformed packets according to a predetermined function of the monitored condition further comprises:
monitoring a location of a receiving mobile station relative to a sending mobile station;
determining that the sending mobile station and the receiving mobile station are operating in a single zone; and
creating and storing the reformed packets at a base transceiver station or base station controller for the single zone without downloading the received packets from a network in response to determining that the sending mobile station and the receiving mobile station are operating in a single zone.

11. The method of claim 2 wherein creating and storing the reformed packets according to a predetermined function of the monitored condition further comprises:
monitoring a location of at least two mobile stations participating in a group call;
determining that the at least two mobile stations participating in the group call are operating in a single zone; and
creating and storing at a base transceiver station for the single zone the reformed packets using frames from each of the at least two mobile stations in response to determining that the sending mobile station and the receiving mobile station are operating in a single zone.

12. The method of claim 1 wherein creating and storing the reformed packets further comprises:
compiling the frames into at least two reformed packets to be sent;
storing each reformed packet; and
sending one reformed packet according to a predetermined function of a signal received from a scheduling circuit.

13. The method of claim 12 wherein sending one reformed packet according to the predetermined function of the signal received from the scheduling circuit further comprises:
receiving a signal from the scheduling circuit indicating the size of a radio frame in which data is to be transmitted to a mobile station;
determining which reformed packet corresponds to the size of the radio frame; and
sending the reformed packet that corresponds to the size of the radio frame in the radio frame to the mobile station.

14. The method of claim 12 wherein sending one reformed packet according to the predetermined function of the signal received from the scheduling circuit further comprises:
receiving a signal from the scheduling circuit indicating immediately consecutive radio frames are assigned to a mobile station;
determining which reformed packet corresponds to the size of the immediately consecutive radio frames; and
sending the reformed packet that corresponds to the size of the immediately consecutive radio frames.

15. The method of claim 1 further comprising:
storing at least a second set of received packets of data;
stripping frames of data from the second set of received packets of data;
storing the frames from the second set of received packets of data;
creating and storing reformed packets using the frames and the frames from the second set of received packets of data.

16. An apparatus comprising:
a receiving buffer that receives and stores data packets;
a send buffer that stores reformed packets;
a condition monitor;
a scheduler circuit;
a processor circuit in communication with the receiving buffer to control the handling of the data packets in the receiving buffer, said processor circuit in communication with the send buffer to control the handling of the reformed packets in the send buffer, said processor circuit in communication with the condition monitor, and said processor circuit in communication with the scheduler circuit to receive signals from the scheduler circuit.

17. The apparatus of claim 16 wherein the condition monitor is at least one from a group comprising:
a quality of signal monitor;
a type of wireless transmission technology monitor;
an amount of unrendered data at a receiving mobile station monitor;
a receiving mobile station buffer space monitor;
an amount of data to send to a receiving mobile station monitor;
an amount of data to send from a sending mobile station monitor;
a location of a receiving mobile station relative to a sending mobile station monitor; and
a location of at least two mobile stations participating in a group call monitor.

18. The apparatus of claim 16 wherein the apparatus is integrated into at least one of the group of structures comprising:
a sending mobile station;
a base transceiver station in communication with the sending mobile station;
a base transceiver station in communication with a receiving mobile station;
a base station controller;
an intervening mobile station; and
a radio access network.

19. An apparatus comprising:
means for receiving and storing sent packets of data;
means for stripping frames of data from received packets of data;
means for storing the frames to provide stored frames; and
means for creating and storing reformed packets using the stored frames.

20. The apparatus of claim 19 further comprising:
means for monitoring a condition of a wireless communication system;
wherein the means for creating and storing reformed packets using the stored frames further comprises means for applying a predetermined function of the condition to create and store the reformed packets;
means for receiving a signal from a scheduling circuit; and
means for sending one reformed packet according to a predetermined function of the signal received from the scheduling circuit.
